(19) United States
(12) Patent Application Publication
(10) Pub. No.: US 2017/0116375 A1
(43) Pub. Date: Apr. 27, 2017

(54) MEDICAL INFORMATION MANAGEMENT SYSTEM AND MANAGEMENT SERVER

(71) Applicant: KONICA MINOLTA, INC., Tokyo (JP)

(72) Inventor: Naokazu KUWAYAMA, Tokyo (JP)

(73) Assignee: KONICA MINOLTA, INC., Tokyo (JP)

(21) Appl. No.: 15/286,183

(22) Filed: Oct. 5, 2016

(30) Foreign Application Priority Data
Oct. 21, 2015 (JP) 2015-206842

(51) Int. Cl. G06F 19/00; G06F 21/62; H04L 29/06

(52) U.S. Cl. CPC G06F 19/322; H04L 67/42; G06F 21/6245; H04L 63/06; H04L 63/061

(57) ABSTRACT

In a medical information management system, a management server which manages medical information generated in medical facilities is connected to client terminals in the medical facilities. The management server includes a first storage, a second storage, a first generator and a second generator. The first storage stores permission information including a disclosee. The second storage stores a partner key with respect to each partner to share the medical information, the partner being a candidate of the disclosee. In response to a download request of the medical information from one of the client terminals, the first generator generates a content key and encrypts the medical information using the content key. The second generator encrypts the content key and the permission information of the encrypted medical information by using the partner key of the disclosee included in the permission information.

### BACKGROUND OF THE INVENTION

1. Field of the Invention

The present invention relates to a medical information management system and a management server.

2. Description of Related Art

In recent years, medical care coordination has become common along with diversification of medical technologies, in which medical facilities such as a hospital providing an advanced treatment and a clinic share medical information and cooperatively perform an examination and a medical treatment of a patient. For example, a system that is currently used is to upload medical information to a server connected via a communication network in such a manner that only a partner can reference and to download the medical information when needed.

A technique has been proposed for a medical care data-sharing server that includes a data-sharing DB for accumulating medical care data owned by medical facilities, in which a determination is made as to whether there is a registered past medical care data of the same patient as a patient of a medical care data uploaded from a medical facility. If there is such a registered medical care data, the uploaded medical care data is registered associated with the management ID of the patient. If no medical care data is registered, the uploaded medical data is registered associated with a new management ID (see JP 2008-204378A).

While such conventional systems are intended to improve work efficiency by sharing medical information among medical facilities, it has been required to restrict reference or external output of information in order to prevent leakage of shared medical information.

For example, when medical information of a type that does not require personal information is shared in a specific partner group, although personal information may sometimes be required, it is desired that such medical information is provided in an anonymous form.

When medical information is referenced from a client terminal such as a mobile terminal and the downloaded medical information is left in the client terminal, there is a risk of leakage of information such as the terminal being lost or the saved medical information being copied.

The safety of data is improved by putting a restriction with respect to each terminal, for example, by permitting a specific client terminal to reference and output medical information or by permitting only to reference medical information while prohibiting to output it.

### SUMMARY OF THE INVENTION

The present invention has been made in view of the above-described problem with the prior art, and an object thereof is to prevent leakage of medical information and also to restrict reference and output of medical information in a system in which the medical information can be shared.

In order to realize the above object, according to a first aspect of the present invention, there is provided a medical information management system comprising:

a management server which manages medical information generated in medical facilities; and

client terminals which are installed in the medical facilities and which are connected to the management server so that data communication is possible,

wherein the management server includes:
a first storage which stores permission information including a disclosee with respect to each of the medical information;
a second storage which stores a partner key with respect to each partner to share the medical information, the partner being a candidate of the disclosee;
a first generator which, in response to a download request of the medical information from one of the client terminals, generates a content key and encrypts the medical information by using the generated content key, so as to generate first information every time the medical information is downloaded;
a second generator which encrypts the content key and the permission information of the medical information encrypted with the content key by using the partner key of the disclosee included in the permission information, so as to generate second information; and
a provider which provides the first information and the second information to the client terminal which makes the download request, and

wherein each of the client terminals includes:
a first retrieving section which retrieves the partner key;
a second retrieving section which decrypts the second information retrieved from the management server by using the partner key retrieved by the first retrieving section, so as to retrieve the content key and the permission information; and
a third retrieving section which decrypts the first information retrieved from the management server by using the content key retrieved by the second retrieving section within a scope of authority according to the permission information retrieved by the second retrieving section, so as to retrieve the medical information.

According to the first aspect of the present invention, it is possible to prevent leakage of medical information and also to restrict reference and output of medical information.

Preferably, the partner key is a user key provided to each user, a terminal key provided to each of the client terminals or a patient key provided to each patient of the medical information.

Preferably, the permission information further includes a validity period or a permission type of the medical information.

Preferably, each of the client terminals further includes a writer which writes the first information and the second information retrieved from the management server to a recording medium when encrypted output is allowed in the permission information retrieved by the second retrieving section.

According to a second aspect of the present invention, there is provided a management server which is connected to client terminals installed in medical facilities so that data communication is possible and which manages medical information generated in the medical facilities, including:

a first storage which stores permission information including a disclosee with respect to each of the medical information;

a second storage which stores a partner key with respect to each partner to share the medical information, the partner being a candidate of the disclosee;

a first generator which, in response to a download request of the medical information from one of the client terminals, generates a content key and encrypts the medical information by using the generated content key, so as to generate first information every time the medical information is downloaded;

a second generator which encrypts the content key and the permission information of the medical information encrypted with the content key by using the partner key of the disclosee included in the permission information, so as to generate second information; and

a provider which provides the first information and the second information to the client terminal which makes the download request.

According to the second aspect of the present invention, it is possible to prevent leakage of medical information and also to restrict reference and output of the medical information.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a system configuration diagram of a medical information management system according to a first embodiment of the present invention;

FIG. 2 is a block diagram of the functional configuration of a management server;

FIG. 3 illustrates an example of permission information;

FIG. 4A is a conceptual view illustrating encryption of shared data;

FIG. 4B is a conceptual view illustrating encryption of a content key and permission information;

FIG. 5 is a block diagram of the functional configuration of a client terminal;

FIG. 6A is a conceptual view illustrating decryption of an encrypted data;

FIG. 6B is a conceptual view illustrating decryption of an encrypted shared data;

FIG. 7 is a ladder chart illustrating a terminal registration sequence.

FIG. 8 is a ladder chart illustrating a user registration sequence.

FIG. 9 is a ladder chart illustrating an upload sequence.

FIG. 10 is a ladder chart illustrating a download sequence.

FIG. 11 is a ladder chart illustrating a download sequence.

FIG. 12 is a ladder chart illustrating a display sequence.

FIG. 13 is a flowchart illustrating an output sequence executed in a client terminal;

FIG. 14 is a system configuration diagram of a medical information management system according to a second embodiment of the present invention;

FIG. 15 is a ladder chart illustrating a patient registration sequence;

FIG. 16 is a ladder chart illustrating a download sequence when a patient key is used.

FIG. 17 is a ladder chart illustrating a download sequence when a patient key is used.

### DETAILED DESCRIPTION OF THE PREFERRED EMBODIMENTS

### First Embodiment

First, a medical information management system according to a first embodiment of the present invention will be described referring to the drawings. However, the present invention is not limited to the illustrated examples.

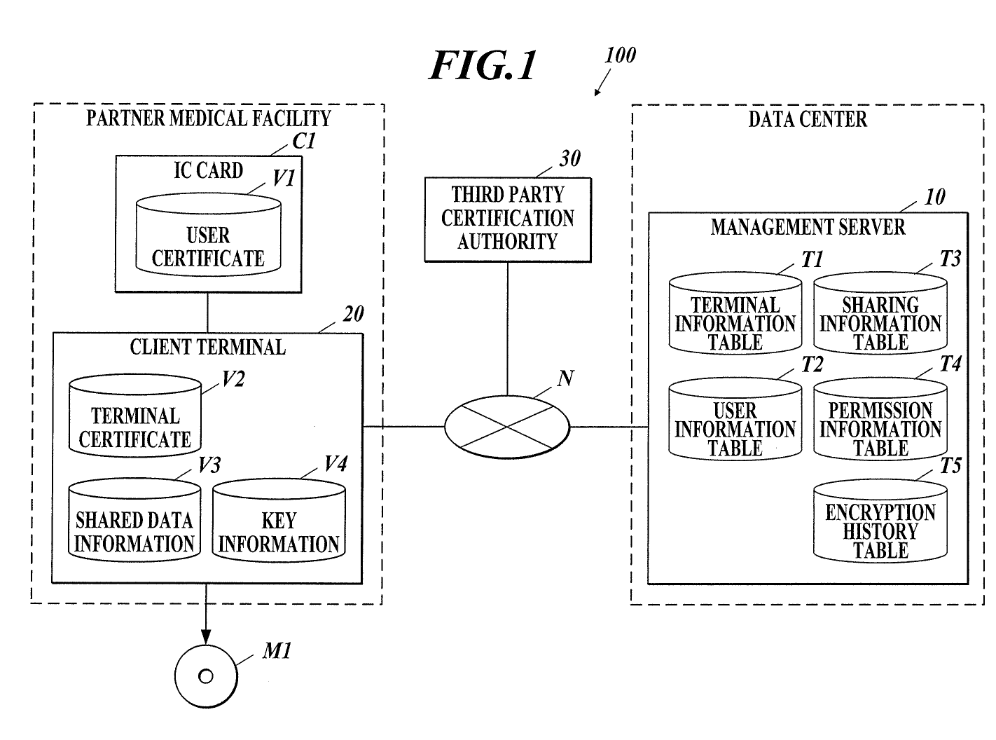

FIG. 1 illustrates the system configuration of the medical information management system 100 according to the first embodiment.

As illustrated in FIG. 1, the medical information management system 100 includes a management server 10 installed in a data center, a client terminal 20 installed in a partner medical facility and a third party authentication authority 30. The management server 10, the client terminal 20 and the third party authentication authority 30 are connected to each other via a communication network N such as the Internet so that data communication is possible.

The number of partner medical facility constituting the medical information management system 100 and the number of client terminal 20 in each partner medical facility are not particularly limited.

The management server 10 stores and manages medical information that is generated in partner medical facilities. Further, the management server 10 is used for providing a medical coordination service between medical facilities. That is, in response to a request from a medical facility, the management server 10 provides an examination result or an image data of a photographed image obtained in other medical facilities.

Medical information is information that is produced in the course of a medical care of a patient. Examples of such medical information include medical image data, laboratory data of a specimen, electronic chart data, interpretation reports, pathological diagnosis reports and the like. Further, the medical information may be image data in which a medical image obtained by photographing a patient is accompanied with supplementary information such as patient information and examination information according to the DICOM (digital imaging and communications in medicine) standard. The medical information may be described in a variety of data formats such as PDF, PNG, Excel and Word.

The management server 10 stores a terminal information table T1, a user information table T2, a sharing information table T3, a permission information table T4 and an encryption history table T5.

The client terminal 20 is a computer that is used for medical coordination of a medical facility with other medical facilities. The client terminal 20 is used to access the management server 10 via the communication network N so as to upload medical information to the management server 10 or to download medical information stored in the management server 10.

The client terminal 20, which is connected to a PACS (picture achieving and communication system) installed in the medical facility via an intra-facility network such as a LAN (local area network) so that data communication is possible, fetches medical information from the PACS. The PACS is an intra-facility server that stores medical information such as an image data of a medical image formed by a modality in the medical facility and patient information and examination information linked to the medical information. Examples of such modalities that can be used include CR (computed radiography), FPD (flat panel detector), CT (computed tomography), MRI (magnetic resonance imaging) and the like.

The client terminal 20 retrieves information from an IC card (integral circuit card) C1 in which a user certificate V1 is stored.

The client terminal 20 stores information such as a terminal certificate V2, shared data information V3 and key information V4.

The client terminal 20 writes medical information of an output object to a recording medium (hereinafter referred to simply as medium) M1.

The third party authentication authority 30 generates a terminal key in response to a request from the client terminal 20. Further, the third party authentication authority 30 verifies a terminal key in response to a request from the management server 10.

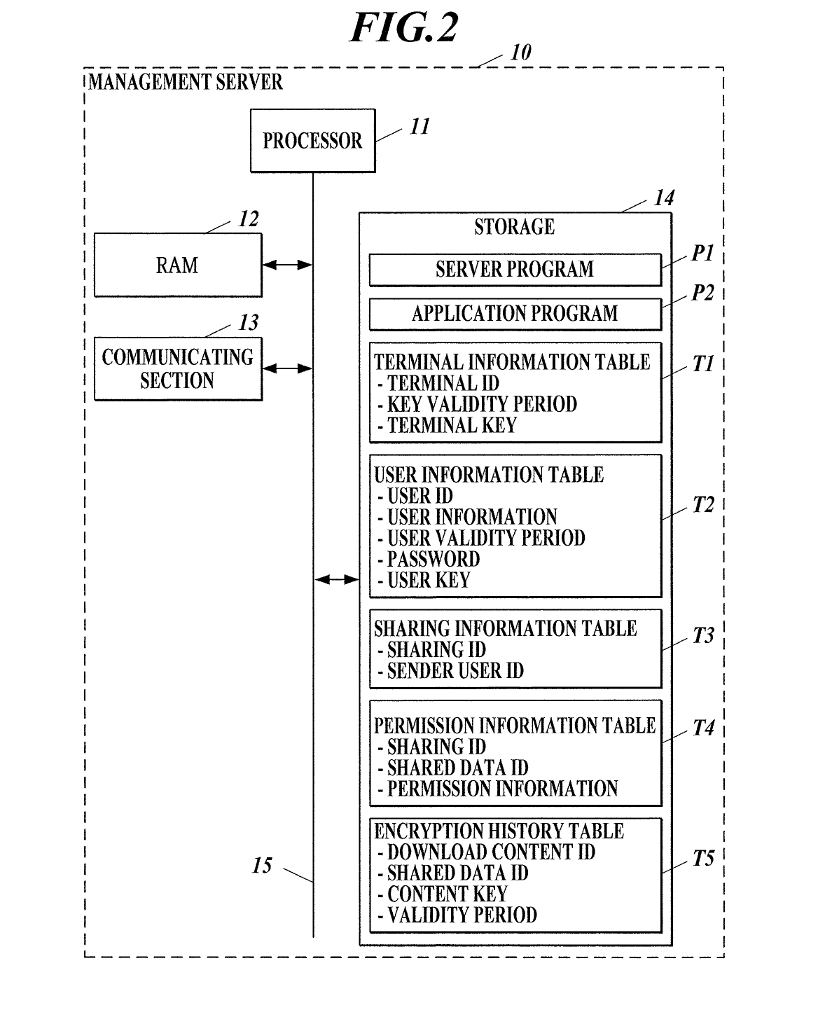

FIG. 2 illustrates the functional configuration of the management server 10.

As illustrated in FIG. 2, the management server 10 includes a processor 11, a RAM (random access memory) 12, a communicating section 13, a storage 14 and the like, which are connected to each other via bus 15.

The processor 11, which is constituted by a CPU (central processing unit) or the like, integrally controls operation and processing in the components of the management server 10. The processor 11 reads out a variety of programs stored in the storage 14 and develops it in the RAM 12, so as to perform a variety of processing in cooperation with the programs.

While the processor 11 executes the variety of processing, the RAM 12 forms a work area which temporarily stores the variety of programs read from the storage 14, input or output data, parameters and the like.

The communicating section 13, which is constituted by a network interface and the like, sends and receives data to and from an external device that is connected via the communication network N. For example, the communicating section 13 receives medical information sent from the client terminal 20. Further, the communicating section 13 sends medical information to the client terminal 20 that made a download request of the medical information.

The storage 14 is constituted by an HDD (hard disk drive), a semiconductor non-volatile memory or the like. The storage 14 stores the variety of programs executed by the processor 11 and also stores parameters and data required for executing the programs. Specifically, a server program P1, an application program P2, the terminal information table T1, the user information table T2, the sharing information table T3, the permission information table T4 and the encryption history table T5 are stored in the storage 14.

The server program P1 is to perform data management processing, processing for providing medical information to a partner medical facility and the like in the management server 10.

The application program P2 is downloaded by the client terminal 20 and used in the client terminal 20.

In the terminal information table T1, information on each of the client terminal 20 that can access to the management server 10 is stored. In the terminal information table T1, a “key validity period” and a “terminal key” are linked to a “terminal ID” (second storage). Each client terminal 20 can be set as a partner to share medical information and is therefore a potential disclosee of the medical information.

The “terminal ID” is identification information for identifying the client terminal 20.

The “key validity period” is a validity period of the “terminal key” that is generated for the client terminal 20 identified by the “terminal ID”.

The “terminal key” is a key unique to each client terminal 20, which is provided for the client terminal 20 identified by the “terminal ID”. For example, the “terminal key” is generated by the third party authentication authority 30.

In the user information table T2, information on each user of the medical information management system 100 is stored. In the user information table T2, “user information”, a “user validity period”, a “password” and a “user key” are linked to a “user ID” (second storage).

Each user can be set as a partner to share medical information and is therefore a potential disclosee of the medical information.

The “user ID” is identification information for identifying a user.

The “user information” is information on a user, which includes the name of his/her organization, authority and the like.

The “user validity period” is a period in which a user identified by the “user ID” is permitted to use the medical information management system 100.

The “password” is a password that is required to input for user authentication when using the medical information management system 100.

The “user key” is a key that is provided to a user identified by the “user ID”, which is unique to each user.

In the sharing information table T3, information on each sending unit (each sharing) of medical information that is sent from the client terminal 20. In the sharing information table T3, a “sender user ID” is linked to a “sharing ID”.

The “sharing ID” is identification information that is provided to each sending unit (each sharing) of medical information that is sent from the client terminal 20 to the management server 10.

The “sender user ID” is a user ID that identifies a sender of medical information.

In the permission information table T4, permission information on each shared data is stored (first storage). In the permission information table T4, a “sharing ID” and “permission information” are linked to a “shared data ID”. The shared data is a set of information that is handled as a single unit when medical information is shared in the medical information management system 100, which is constituted by one or more files.

The “shared data ID” is identification information provided to each unit (shared data) of medical information that is encrypted with one content key.

The “permission information” represents authority to medical information, which is set with respect to each medical information (shared data). The “permission information” includes a disclosee such as a user or a client terminal 20 that is permitted to perform processing, a validity period of medical information and the like.

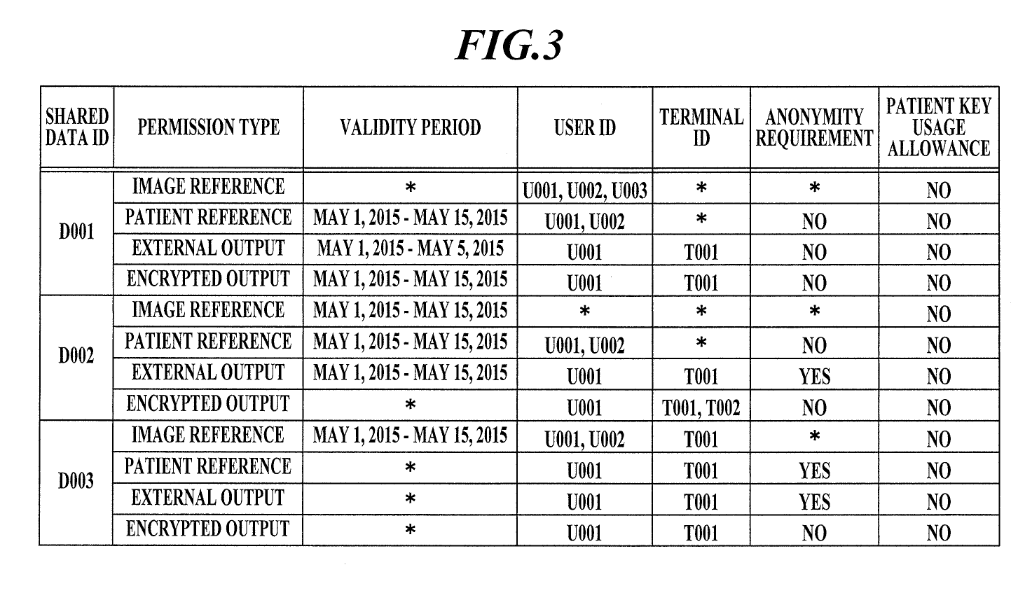

FIG. 3 illustrates an example of the permission information.

In the permission information, the validity period, the user ID, the terminal ID and anonymity requirement are linked to each permission type of each shared data ID. The patient key usage allowance listed in Table 3 is not used in the first embodiment and will be described in a second embodiment.

The permission type is classification of processing that is performed on shared data. In this embodiment, permission types include image reference, patient reference, external output and encrypted output. The image reference refers to reference to (display of) an image part of shared data. The patient reference refers to reference to (display of) patient information part of shared data. The external output refers to output (write) of shared data to the medium M1. The encrypted output refers to output (write) of encrypted shared data to the medium M1.

The validity period is a period in which reference and/or output is permitted.

The user IDs included in the permission information correspond to users who are permitted to reference and/or output shared data.

The terminal IDs included in the permission information correspond to client terminals 20 that are permitted to reference and/or output shared data.

The anonymity requirement is information on whether it is required to hide personal information in shared data such as patient information.

In the example of FIG. 3, regarding “image reference” of the shared data of the shared data ID “D001”, the users of user IDs “U001”, “U002” and “U003” are allowed. Further, regarding “image reference” of the shared data of the shared data ID “D001”, neither validity period nor terminal ID is specified, and the image can therefore be referenced any time from any client terminal 20.

Regarding “patient reference” of the shared data of the shared data ID “D001”, the users of the user IDs “U001” and “U002” are allowed in the period of “May 1, 2015 to May 15, 2015”.

Regarding “external output” of the shared data of the shared data ID “D001”, the user of the user ID “001” is allowed in the period of “May 1, 2015 to May 5, 2015” only from the client terminal 20 of the terminal ID “T001”.

Regarding “encrypted output” of the shared data of the shared data ID “D001”, the user of the user ID “U001” is allowed in the period of “May 1, 2015 to May 15, 2015” only from the client terminal 20 of the terminal ID “T001”.

Regarding “image reference” of the shared data of a shared data ID “D002”, any user is allowed in the period of “May 1, 2015 to May 15, 2015” from any client terminal 20.

In the encryption history table T5, information on each download is stored. In the encryption history table T5, the “shared data ID”, the “content key” and a “validity period” are linked to a “download content ID”.

The “download content ID” is identification information that is provided to each download of medical information (shared data).

The “shared data ID” is the shared data ID of shared data of a download object.

The “content key” is a key that is generated for each download.

The “validity period” is a validity period of the “content key”.

The processor 11 manages medical information sent from the client terminal 20 and provides medical information in response to a request from the client terminal 20 according to the server program P1 stored in the storage 14.

In response to a download request of medical information (shared data) from any one of client terminals 20, the processor 11 generates a content key and encrypts the medical information by using the generated content key so as to generate an encrypted shared data every time the medical information is downloaded, which corresponds to first information. That is, the processor 11 functions as a first generator.

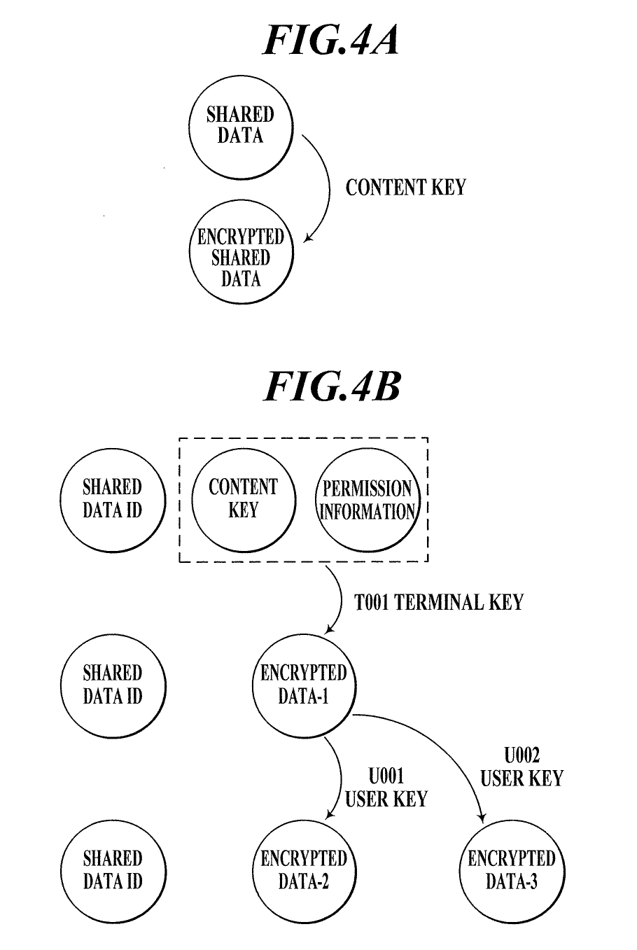

FIG. 4A schematically illustrates the encryption of shared data. The shared data is encrypted with a content key so that a encrypted shared data is obtained.

The processor 11 retrieves permission information of the medical information (shared data) encrypted with the content key from the permission information table T4 stored in the storage 14.

Further, the processor 11 retrieves partner keys (terminal key, user key) of disclosees (terminal ID, user ID) included in the retrieved permission information from the terminal information table T1 and the user information table T2 stored in the storage 14.

The processor 11 encrypts the content key and the permission information of the medical information (shared data) encrypted with the content key by using the partner keys of the disclosees included in the permission information, so as to generate an encrypted data, which corresponds to second information. That is, the processor 11 functions as a second generator.

FIG. 4B is a conceptual view illustrating the encryption of a content key and permission information. In the figure, the users of the user IDs “U001” and “U002” are permitted to perform processing on an object shared data from the client terminal 20 of the terminal ID “T001”. First, the content key and the permission information are encrypted by using a terminal key of the terminal ID “T001”, so that an encrypted data−1 is generated. Then, the encrypted data-1 is further encrypted by using a user key of the user ID “0001”, so that an encrypted data-2 is generated. The encrypted data−1 is also encrypted by using a user key of the user ID “U002”, so that an encrypted data-3 is generated. In each step of the processing, the content key and the permission information are linked to a shared data ID for the management.

The processor 11 provides the encrypted shared data and the encrypted data via the communicating section 13 to the client terminal 20 that made a download request. That is, the processor 11 functions as a provider. Every time the shared data is downloaded, the content key is saved in the encryption history table T5 of the management server 10. Accordingly, it is not required to save the encrypted shared data in the management server 10.

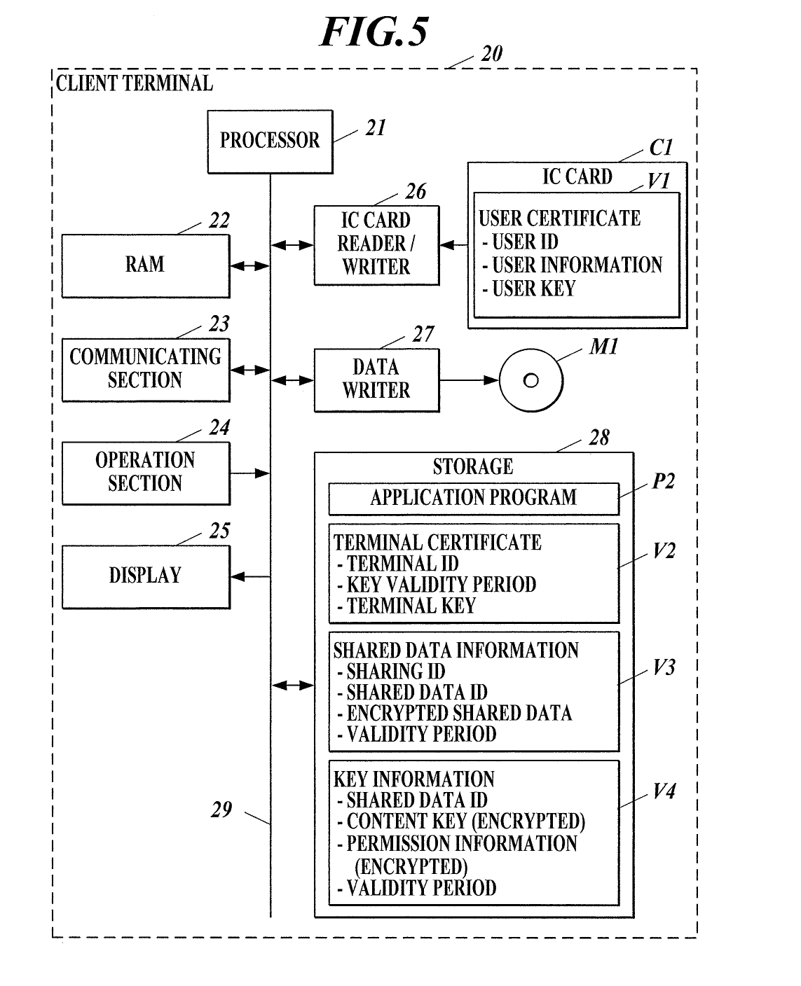

FIG. 5 illustrates the functional configuration of the client terminal 20.

As illustrated in FIG. 5, the client terminal 20 includes a processor 21, a RAM 22, a communicating section 23, an operation section 24, a display 25, an IC card reader/writer 26, a data writer 27, a storage 28 and the like, which are connected to each other via a bus 29 or the like.

The processor 21, which is constituted by a CPU or the like, integrally controls operation and processing in the components of the client terminal 20. The processor 21 reads a variety of programs stored in the storage 28, develops them on the RAM 22 and executes a variety of processing in cooperation with the programs.

While the processor 21 performs the variety of processing, the RAM 22 forms a work area which temporarily stores the variety of programs read from the storage 28, input or output data, parameters and the like.

The communicating section 23 is constituted by a network interface and the like, and sends and receives data to and from an external device that is connected via the communication network N or an intra-facility network. For example, the communicating section 23 sends medical information to the management server 10 and receives medical information from the management server 10.

The operation section 24 includes a keyboard including cursor keys, numeric keys and a variety of function keys, and a pointing device such as a mouse. The operation section 24 outputs an operation signal input by a key operation on the keyboard or a mouse operation to the processor 21. For example, a user who operates the client terminal 20 uses the operation section 24 to select medical information to be uploaded to the management server 10 or to select medical information to be downloaded from the management server 10.

The display 25 includes a monitor such as an LCD (liquid crystal display) and displays a variety of screens according to a display signal input from the processor 21.

The IC card reader/writer 26 reads a variety of data from the IC card C1 and outputs the read data to the processor 21.

The IC card C1 is owned by each user and stores the user certificate V1 of the user. The user certificate V1 includes the “user ID”, the “user information” and the “user key”.

The data writer 27 writes a variety of data to the medium M1 such as a CD-R or DVD-R according to a control signal from the processor 21.

The storage 28 is constituted by an HDD, a semiconductor non-volatile memory or the like. The storage 28 stores a variety of programs executed by the processor 21 and also stores parameters and data required for executing the programs. Specifically, an application program P2, a terminal certificate V2, shared data information V3, key information V4 and the like are stored in the storage 28.

The application program P2 is a program for performing upload or download processing of medical information and the like in the client terminal 20. The application program P2 is downloaded from the management server 10 and used.

The terminal certificate V2 is information that proves the client terminal 20 is permitted to access the management server 10, and includes the “terminal ID”, the “key validity period” and the “terminal key”.

The shared data information V3 is information on medical information (shared data) downloaded from the management server 10, and includes the “sharing ID”, the “shared data ID”, the “encrypted shared data” and the “validity period”.

The key information V4 is information on a key for decrypting an encrypted shared data, and includes the “shared data ID”, the “encrypted data (encrypted content key and permission information)” and the “validity period”.

When uploading medical information, the processor 21 sends medical information (shared data) selected on the operation section 24 to the management server 10 via the communicating section 23.

When downloading medical information, the processor 21 retrieves a shared data ID, and encrypted shared data and all of encrypted data (encrypted content key and permission information) that are linked to the shared data ID from the management server 10 via the communicating section 23.

The processor 21 controls the IC card reader/writer 26 to retrieve the user key (partner key) stored in the IC card C1. Further, the processor 21 retrieves the terminal key (partner key) from the terminal certificate V2 stored in the storage 28. That is, the processor 21 functions as a first retrieving section.

The processor 21 checks whether the encrypted data retrieved from the management server 10 can be decrypted by using the keys in the client terminal 20. It is predetermined between the management server 10 and the client terminal 20 which of a user key, a terminal key and both user key and terminal key is used for the encryption. When both user key and terminal key are used, the order thereof is also predetermined.

The processor 21 decrypts the encrypted data retrieved from the management server 10 by using the user key retrieved from the user certificate V1 in the IC card C1 and/or the terminal key retrieved from the terminal certificate V2 in the storage 28, so as to retrieve the content key and permission information. That is, the processor 21 functions as a second retrieving section.

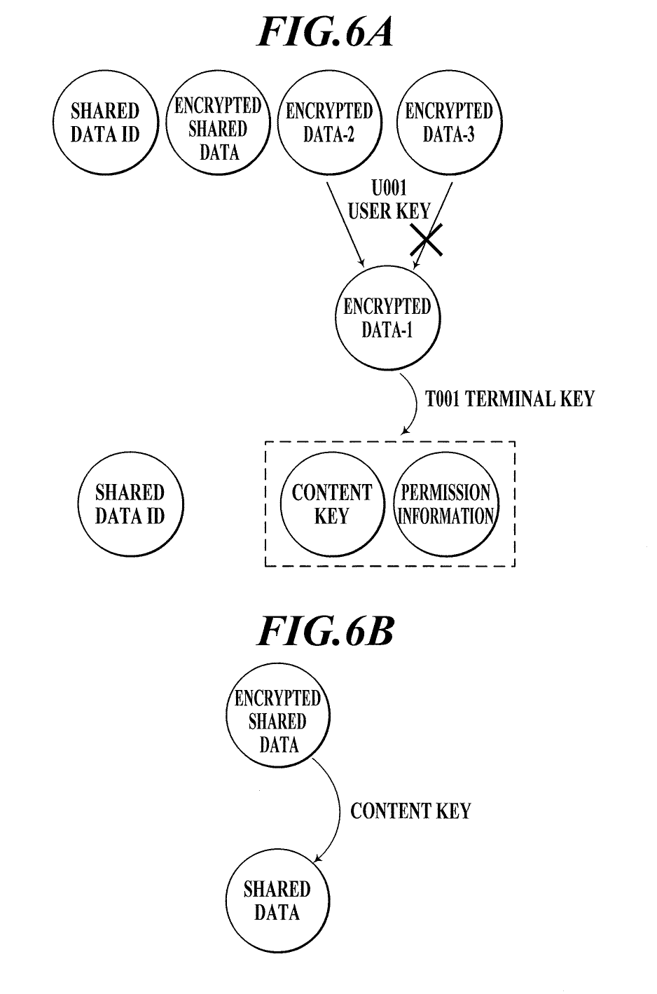

FIG. 6A is a conceptual view illustrating the decryption of an encrypted data. In the figure, the terminal ID of the client terminal 20 in use is “T001”, and the user ID of the current user is “U001”. Further, the encrypted data-2 and encrypted data-3 are those generated as described in FIG. 4B. When decryption of the encrypted data-2” is attempted by using the user key of the user ID “U001, the decryption succeeds, and the encrypted data 1 is obtained. In contrast, when decryption of the encrypted data-3 is attempted by using the user key of the user ID “U001”, the decryption fails since the decryption data-3 is encrypted by using the user key of the user ID “U002”. Next, when decryption of the encrypted data-1 is attempted by using the terminal key of the terminal ID “T001”, the decryption succeeds, and the content key and the permission information are obtained.

The processor 21 decrypts an encrypted shared data retrieved from the management server 10 by using the retrieved content key within the scope of authority according to the retrieved permission information, so as to retrieve the medical information (shared data). That is, the processor 21 functions as a third retrieving section.

FIG. 6B is a conceptual view illustrating the decryption of an encrypted shared data. The encrypted shared data is decrypted by using a content key so that shared data is obtained.

When encrypted output is allowed according to the retrieved permission information, the processor 21 controls the data writer 27 to write the encrypted shared data and the encrypted data retrieved from the management server 10 to the medium M1.

The content key, terminal key and user key may be based on either symmetric-key cryptography in which a same key is used for both encryption and decryption or public-key cryptography in which different keys (a pair of a public key and a private key) are used respectively for encryption and decryption.

Next, operation of the medical information management system 100 will be described. In the following processing, the processing in the management server 10 is achieved by software processing of the processor 11 in cooperation with the server program P1 stored in the storage 14, and the processing in the client terminal 20 is achieved by software processing of the processor 21 in cooperation with the application program P2 stored in the storage 28.

### Terminal Registration Sequence

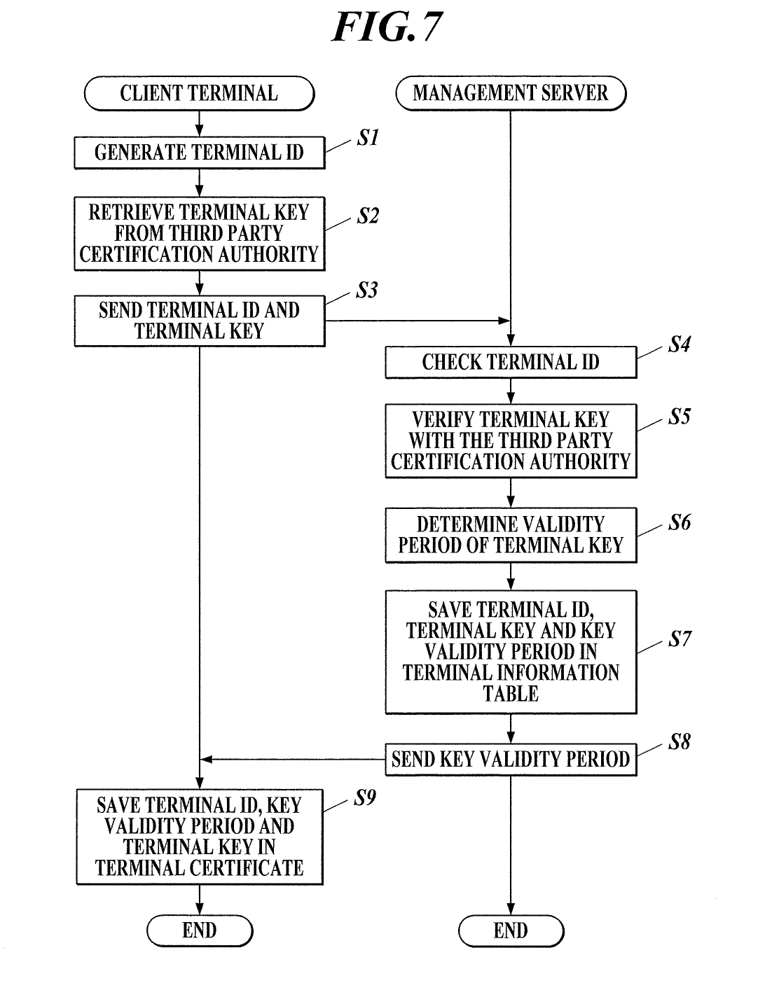

FIG. 7 is a ladder chart illustrating a terminal registration sequence. The terminal registration sequence illustrates the process of generating an electronic certificate (terminal certificate V2) in the medical information management system 100. The electronic certificate proves that the client terminal 20 is an authorized terminal. Typically, only a limited user (e.g. administrator of a partner medical facility, etc.) can do this in normal system operation. However, it is not essential to put such restriction.

First, in the client terminal 20, the processor 21 generates a terminal ID that does not overlap with those of the other client terminals 20, for example, by generating a random number (Step S1). For example, “FEA92C15-6EE4-4665-A0B0-C491E30B85E7” is used as the terminal ID.

Then, the processor 21 accesses the third party authentication authority 30 via the communicating section 23 and requests generation of a terminal key of the terminal ID, so as to retrieves the terminal key from the third party authentication authority 30 (Step S2). In the third party authentication authority 30, the terminal ID and the terminal key linked to the terminal ID are stored.

Then, the processor 21 sends the terminal ID and the terminal key to the management server 10 via the communicating section 23 (step S3) and requests registration of the client terminal 20.

When the management server 10 receives the terminal ID and the terminal key from the client terminal 20 via the communicating section 13, the processor 11 references the terminal information table T1 to check that the terminal ID is not overlapped in the table (Step S4). When the terminal ID is overlapped, the processor 11 requests the client terminal 20 to regenerate the terminal ID.

Then, the processor 11 accesses to the third party authentication authority 30 via the communicating section 13 and requests verification of the terminal key (Step S5). The third party authentication authority 30 notifies the management server 10 that the terminal ID and the terminal key is a correct combination.

Then, the processor 11 determines the validity period (key validity period) of the terminal key (Step S6). The key validity period may be based on a predetermined period or be determined according to a predetermined condition.

Then, the processor 11 links the terminal ID and the terminal key received from the client terminal 20 and the key validity period determined in Step S6 to each other and saves them in the terminal information table T1 (Step S7). The information is saved in such a state that cannot be referenced without using the server program P1 of the medical information management system 100.

Then, the processor 11 sends the key validity period to the client terminal 20 via the communicating section 13 (Step S8).

In the client terminal 20, the processor 21 saves the terminal ID generated in Step S1, the key validity period received from the management server 10 and the terminal key retrieved in Step S2 in the storage 28 as a terminal certificate V2 (Step S9). The information is saved in such a state that cannot be referenced without authority to use the client terminal 20.

Then, the terminal registration sequence ends.

### User Registration Sequence

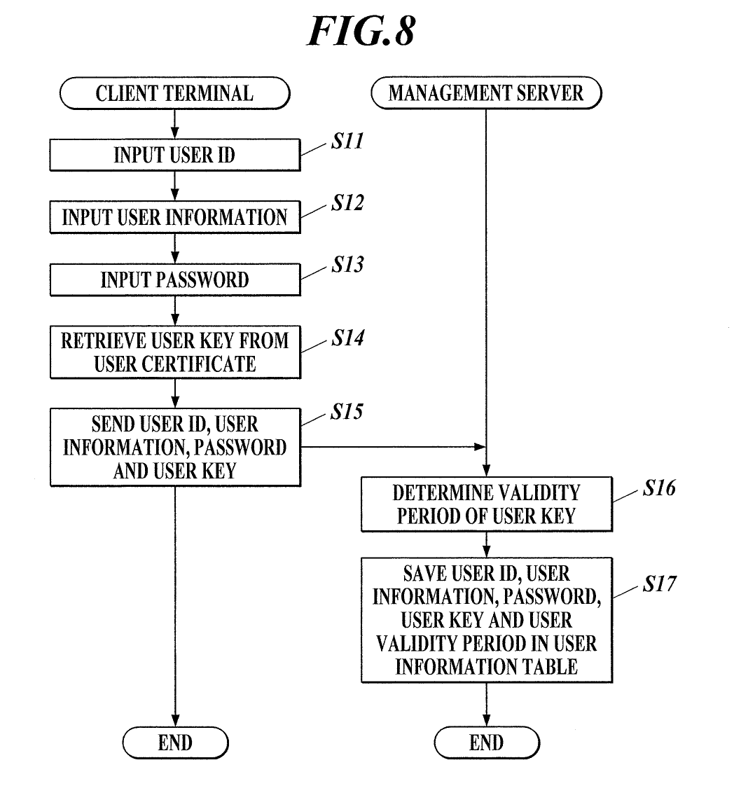

FIG. 8 is a ladder chart illustrating a user registration sequence. The user registration sequence illustrates the process of registering a user as an authorized user in the medical information management system 100.

First, in the client terminal 20, the user inputs a user ID, user information and a password on the operation section 24, and the processor 21 retrieves the input information (Step S11, Step S12 and Step S13).

Then, the processor 21 controls the IC card reader/writer 26 to read the IC card C1 so as to retrieve the user key from the user certificate V1 (Step S14). The user ID and the user information may be retrieved from the user certificate V1.

Then, the processor 21 sends the user ID, the user information, the password and the user key to the management server 10 via the communicating section 23 (Step S15) and requests registration of the user.

When the management server 10 receives the user ID, the user information, the password and the user key from the client terminal 20 via the communicating section 13, the processor 11 determines a validity period (user validity period) of the user key (Step S16). The user validity period may be based on a predetermined period or be determined according to a predetermined condition.

Then, the processor 11 links the user ID, the user information, the password and the user key which are received from the client terminal 20 and the user validity period determined in Step S16 to each other and saves them in the user information table T2 (Step S17). The information is saved in such a state that cannot be referenced without the server program P1 of the medical information management system 100.

Then, the user registration sequence ends.

In the following processing, when the client terminal 20 accesses the management server 10, the user ID and the password are input on the client terminal 20 and the management server 10 performs user certification before the processing starts.

When the user validity period of a user ID in the user information table T2 has already ended, the management server 10 denies an access of the user of the user ID.

### Upload Sequence

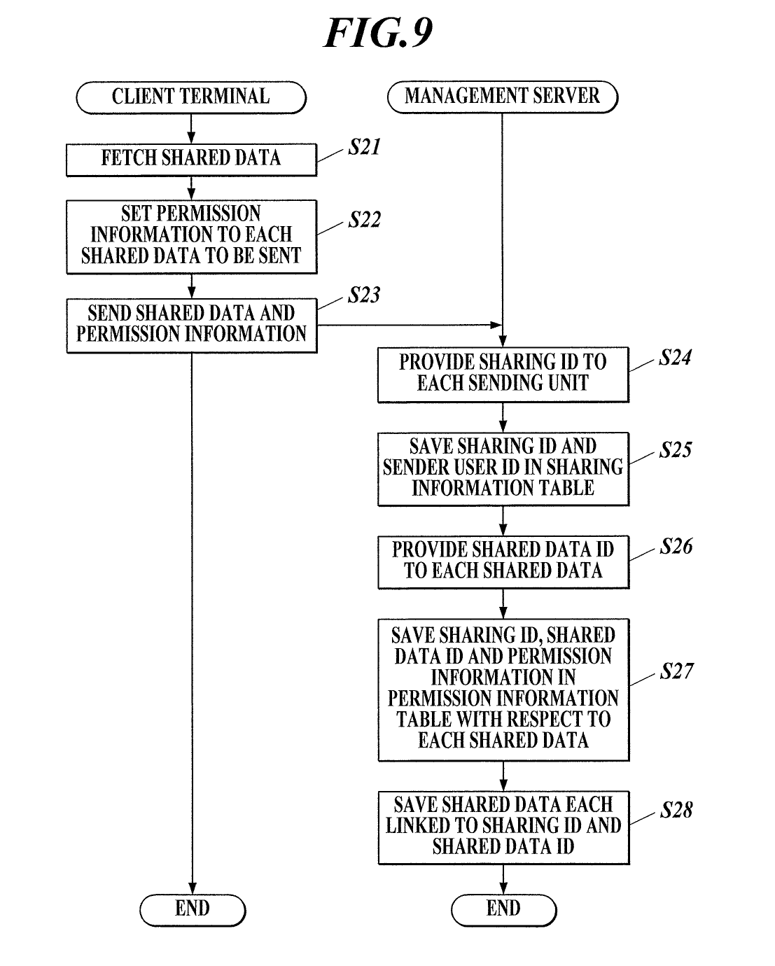

FIG. 9 illustrates a ladder chart illustrating an upload sequence. The upload sequence illustrates the process of uploading medical information from the client terminal 20 to the management server 10. When uploading medical information, the client terminal 20 sets permission information, which serves as conditions for referencing and/or outputting the medical information.

First, in the client terminal 20, the processor 21 fetches shared data (medical information) of an upload object from a PACS or the like installed in a medical facility in response to a user operation on the operation section 24 (Step S21).

Then, the processor 21 sets permission information with respect to each shared data to be sent according to a user operation on the operation section 24 (Step S22). The permission information includes a validity period in which the shared data can be referenced and/or output, the user ID of a user who can reference and/or output the shared data, the terminal ID of a terminal from which the shared data can be referenced and/or output, anonymity requirement, and the like. As in the example of FIG. 3, authority may be set with respect to each permission type. The display 25 of the client terminal 20 displays an operation screen for setting or selecting the disclosee of the shared data, including the way of setting the disclosee such as user-based setting, terminal-based setting and user-terminal combination-based setting.

Then, the processor 21 sends the shared data and the permission information linked to the shared data to the management server 10 via the communicating section 23 (Step S23), and requests upload of the shared data.

When the management server 10 receives the shared data and the permission information via the communicating section 13, the processor 11 provides a sharing ID to the sending unit (including one or more shared data) sent from the client terminal 20 (Step S24).

Then, the processor 11 links the sharing ID provided in Step S24 to the sender user ID of the current user of the client terminal 20 and saves them in the sharing information table T3 (Step S25).

Then, the processor 11 provides a shared data ID to each of the shared data (Step S26).

Then, the processor 11 links the sharing ID provided in Step S24, the shared data ID of the shared data provided in Step S26 and the permission information of the shared data received from the client terminal 20 to each other with respect to each of the shared data and saves them in the permission information table T4 (Step S27).

Then, the processor 11 links each of the shared data to the sharing ID and the shared data ID with respect to each of the shared data and saves them (Step S28). For example, in the storage 14, the processor 11 creates a folder with the name of the “sharing ID” and further creates a folder with the name of the “shared data ID” of each shared data in a subdirectory thereof, and stores the shared data in the corresponding folder. Regarding a DICOM image, the image data part and the supplementary information part such as patient information are saved separately from each other.

Then, the upload sequence ends.

### Download Sequence

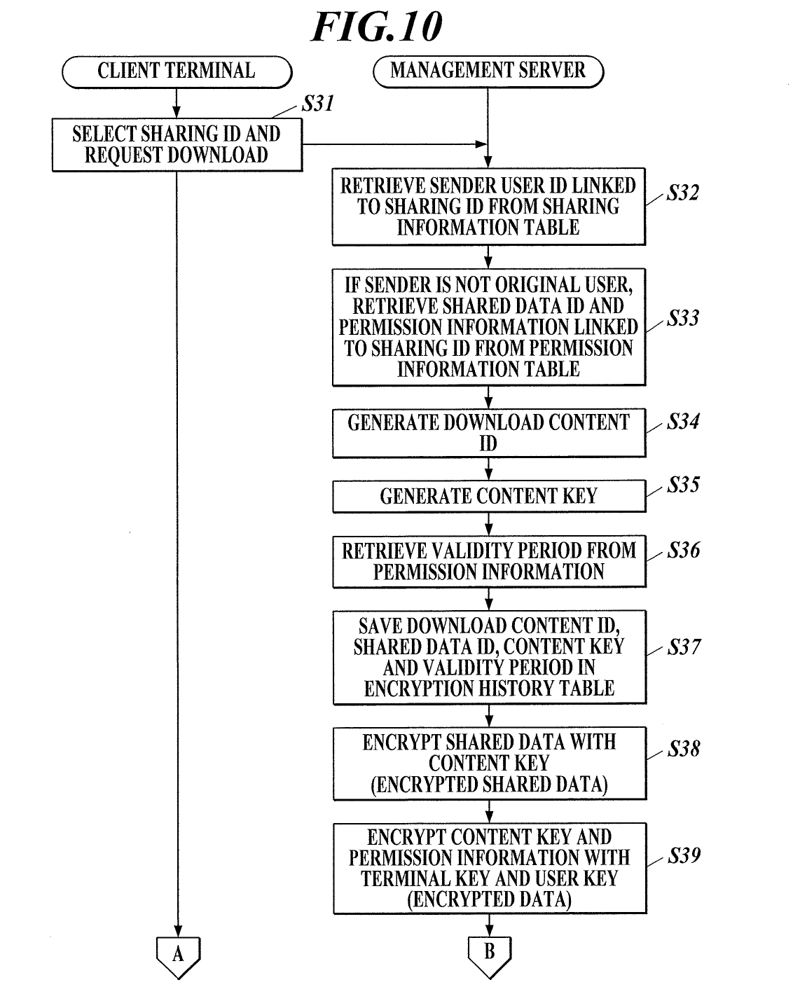

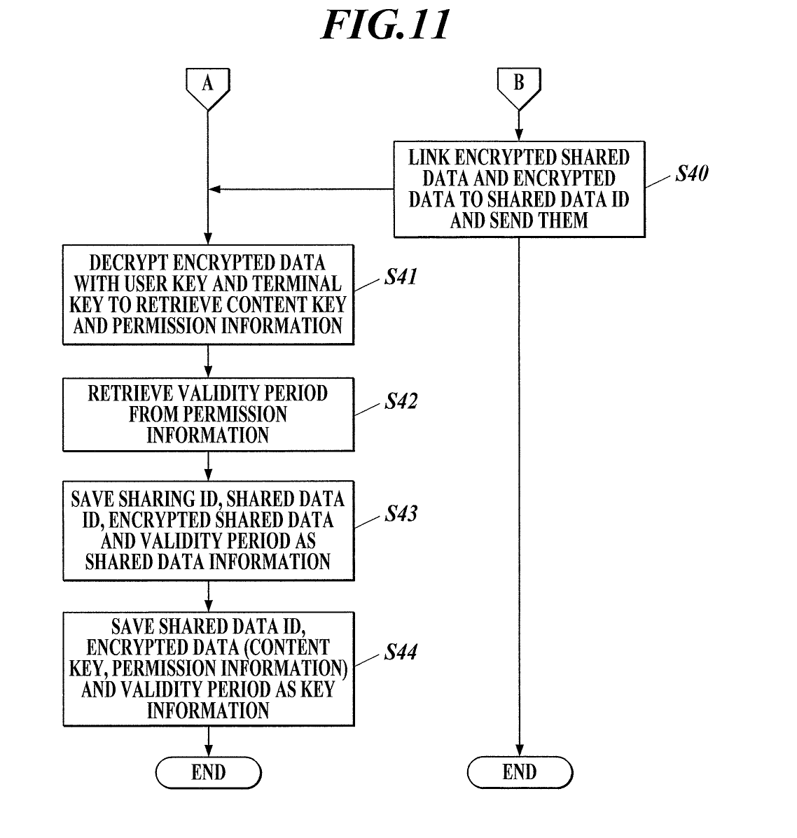

FIG. 10 and FIG. 11 illustrate a ladder chart illustrating a download sequence. The download sequence illustrates the process of the client terminal 20 downloading medical information from the management server 10.

In the client terminal 20, the processor 21 retrieves a list of available medical information (sharing ID) from the management server 10 based on the current user and controls the display 25 to display the retrieved list.

In response to a user operation on the operation section 24 to select a sharing ID, the processor 21 sends a download request to the management server 10 via the communicating section 23 based on the selected shared ID (Step S31).

When the management server 10 receives the download request from the client terminal 20 via the communicating section 13, the processor 11 retrieves the sender user ID linked to the selected sharing ID from the sharing information table T3 (Step S32).

When the user of the “sender user ID” is not the current logged in user of the client terminal 20 himself, the processor 11 retrieves shared data ID and permission information linked to the sharing ID from the permission information table T4 (Step S33). When two or more shared data IDs are linked to the sharing ID, the candidates are displayed on the client terminal 20, and shared data of the shared data ID selected by the user is set as a download object.

It is possible to reference and/or output information that has been uploaded by the currently logged in user of the client terminal 20. Therefore, the description thereof is omitted.

Next, the processor 11 generates a download content ID of the current download (Step S34).

Further, the processor 11 generates a content key for the current download by utilizing a random number, which is used for encrypting the shared data (Step S35).

The processor 11 retrieves a validity period from the permission information retrieved in Step S33 (Step S36). Specifically, a period that covers all of the validity periods of the permission types included in the permission information is set as the validity period of the shared data.

Then, the processor 11 links the download content ID generated in Step S34, the shared data ID of the shared data of the download object, the content key generated in Step S35 and the validity period retrieved in Step S36 to each other and saves them in the encryption history table T5 (Step S37).

Then, the processor 11 encrypts the shared data of the download object by using the content key so as to generate an encrypted shared data (Step s38). In this step, when the anonymity requirement is “Yes” in all permission types of the shared data in the permission information of the shared data, the processor 11 anonymizes personal information included in the shared data such as patient information by replacing it with an asterisk or the like, and encrypts the anonymized shared data by using the content key.

Then, the processor 11 encrypts the content key generated in Step S35 and the permission information retrieved in Step S33 by using a terminal key and a user key, so as to generate an encrypted data (Step S39). Specifically, the processor 11 firstly retrieves a terminal ID that is permitted to reference or output the data in the permission information, retrieves the terminal key of the terminal ID from the terminal information table T1 and encrypts the content key and the permission information by using the terminal key. When two or more terminals are permitted to reference or output the data in the permission information, the processor 11 encrypts the content key and the permission information by using each of the terminal keys of the terminal IDs. Subsequently, the processor 11 retrieves a user ID that is permitted to reference or output the data in the permission information, retrieves the user key of the user ID from the user information table T2, and uses the user key to encrypt the content key and the permission information that has been encrypted with the terminal key. When two or more user IDs are permitted to reference or output the data in the permission information, the processor 11 uses each of the user keys of the user IDs to encrypt the content key and the permission information that has been encrypted by using the terminal key.

When the key validity period of the terminal ID has already ended in the terminal information table T1, it is determined that the terminal key of the terminal ID is not available.

Then, continued to FIG. 11, the processor 11 links the encrypted shared data and the encrypted data to the shared data ID and sends them to the client terminal 20 via the communicating section 13 (Step S40). The encrypted data that is sent includes all of the encrypted data that has been generated with respect to each of the combinations of the terminal ID and the user ID which are specified in the permission information.

When the client terminal 20 receives the shared data ID, the encrypted shared data and the encrypted data via the communicating section 23, the processor 21 controls the IC card reader/writer 26 to retrieve the user key from the user certificate V1 stored in the IC card C1 and also retrieves the terminal key from the terminal certificate V2 stored in the storage 28. The processor 21 then attempts to decrypt the encrypted data by using the user key and the terminal key.

When the key validity period of the terminal key has already ended in the terminal certificate V2, it is determined that the terminal key is not available.

When the user of the client terminal 20 and the client terminal 20 are allowed to reference or output the data, the processor 21 decrypts the encrypted data by using the user key and the terminal key so as to retrieve the content key and the permission information (Step S41).

Then, the processor 21 retrieves a validity period from the retrieved permission information (Step S42). Specifically, a period that covers all of the validity periods of the permission types included in the permission information is set as the validity period of the shared data.

Then, the processor 21 saves the sharing ID selected in Step S31, the shared data ID of the downloaded shared data, the encrypted shared data received from the management server 10 and the validity period retrieved in Step S42 in the storage 28 as the shared data information V3 (Step S43).

Then, the processor 21 saves the shared data ID of the downloaded shared data, the encrypted data (encrypted content key and permission information) received from the management server 10 and the validity period retrieved in Step S42 in the storage 28 as the key information V4 (Step S44).

Then, the download sequence ends.

When the user ID and the terminal ID are not specified in any permission type in the permission information of the shared data, the shared data is not encrypted but is directly downloaded. In this case, no content key is generated, either. In the client terminal 20, information “no key” is saved in the key information V4.

When the anonymity requirement of the shared data is “Yes” and the user ID and the terminal ID are not specified in the permission information, the shared data is anonymized but is not encrypted.

### Display Sequence

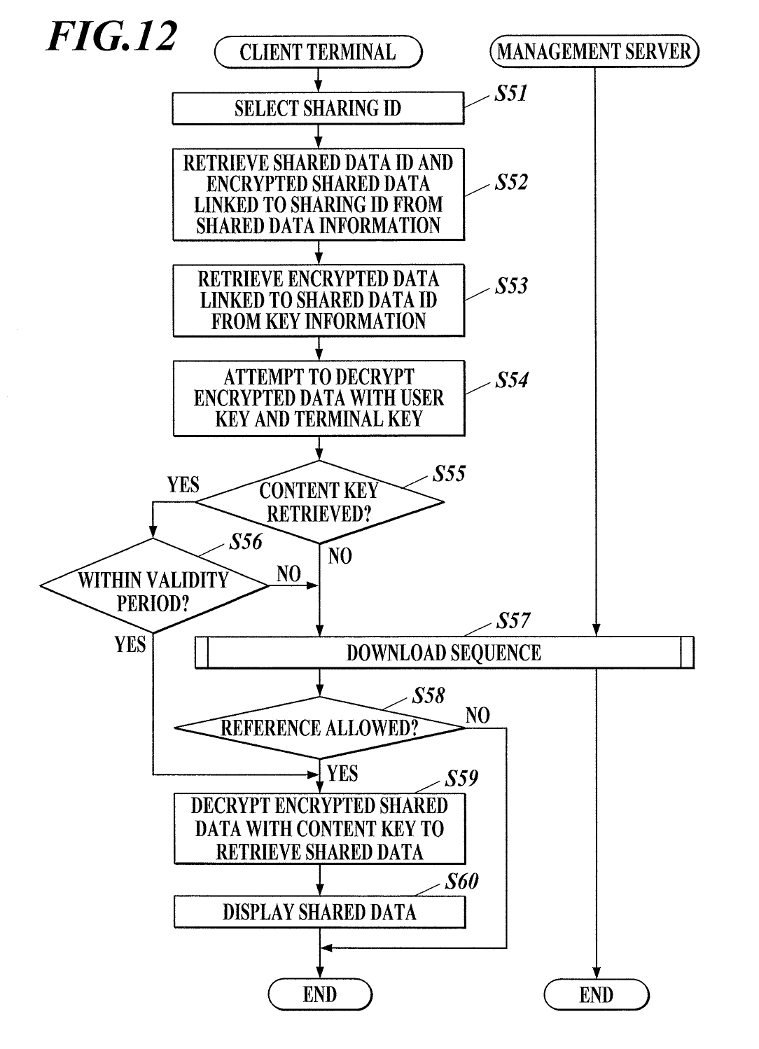

FIG. 12 is a ladder chart illustrating a display sequence. The display sequence illustrates the process of displaying downloaded medical information.

In the client terminal 20, in response to a user operation on the operation section 24 to select a sharing ID (Step S51), the processor 21 retrieves the shared data ID and the encrypted shared data linked to the selected sharing ID from the shared data information V3 stored in the storage 28 (Step S52).

Then, the processor 21 retrieves the encrypted data (encrypted content key and permission information) linked to the shared data ID retrieved in Step S52 from the key information V4 stored in the storage 28 (Step S53).

Then, the processor 21 attempts to decrypt the encrypted data by using the user key included in the user certificate V1 and the terminal key included in the terminal certificate V2 (Step S54).

When the attempt to decrypt the encrypted data with the user key and the terminal key succeeds so that the content key is retrieved (Step S55, Yes), the processor 21 makes a determination as to whether reference of the shared data is in the validity period based on the permission information retrieved by decrypting the encrypted data (Step S56). When two or more permission types such as “image reference” and “patient reference” are defined as reference of the shared data, the determination can be made based on the information on an appropriate permission type.

If the content key is not retrieved in Step S55 (Step S55, No), or if reference of the shared data is not in the validity period in Step S56 (Step S56, No), the client terminal 20 and the management server 10 executes the download sequence (see FIG. 10 and FIG. 11) (Step S57).

In the client terminal 20, after re-downloading the shared data, the processor 21 makes a determination as to whether reference of the object shared data is allowed (Step S58). Specifically, the processor 21 attempts to decrypt the encrypted data by using the user key of the user certificate V1 and the terminal key of the terminal certificate V2. If the attempt to decrypt the encrypted data with the user key and the terminal key succeeds, the processor 21 retrieves the content key and the permission information. Then, if the user of the client terminal 20 and the client terminal 20 are allowed to reference the data and the reference is in the validity period in the permission information, the processor 21 determines that reference of the object shared data is allowed. If the user of the client terminal 20 or the client terminal 20 is not allowed to reference the data, or the reference is not in the validity period, or the decryption of the encrypted data with the user key and the terminal key fails, the processor 21 then determines that reference of the object shared data is not allowed.

If reference of the object shared data is allowed (Step S58, Yes), or if reference of the shared data is in the validity period in Step S56 (Step S56, Yes), the processor 21 decrypts the encrypted shared data by using the content key so as to retrieve the shared data (Step S59).

The processor 21 controls the display 25 to display the retrieved shared data (Step S60).

After Step S60 is performed, or if reference of the object shared data is not allowed in Step S58 (Step S58, No), the display sequence ends.

In the above description, the management server 10 and the client terminal 20 are connected to each other so that communication is possible. However, when the encrypted shared data and the encrypted data are saved in the client terminal 20, it is possible to reference the data by using the keys (user key and terminal key) that the client terminal 20 can use, even when the client terminal 20 is offline.

### Output Sequence

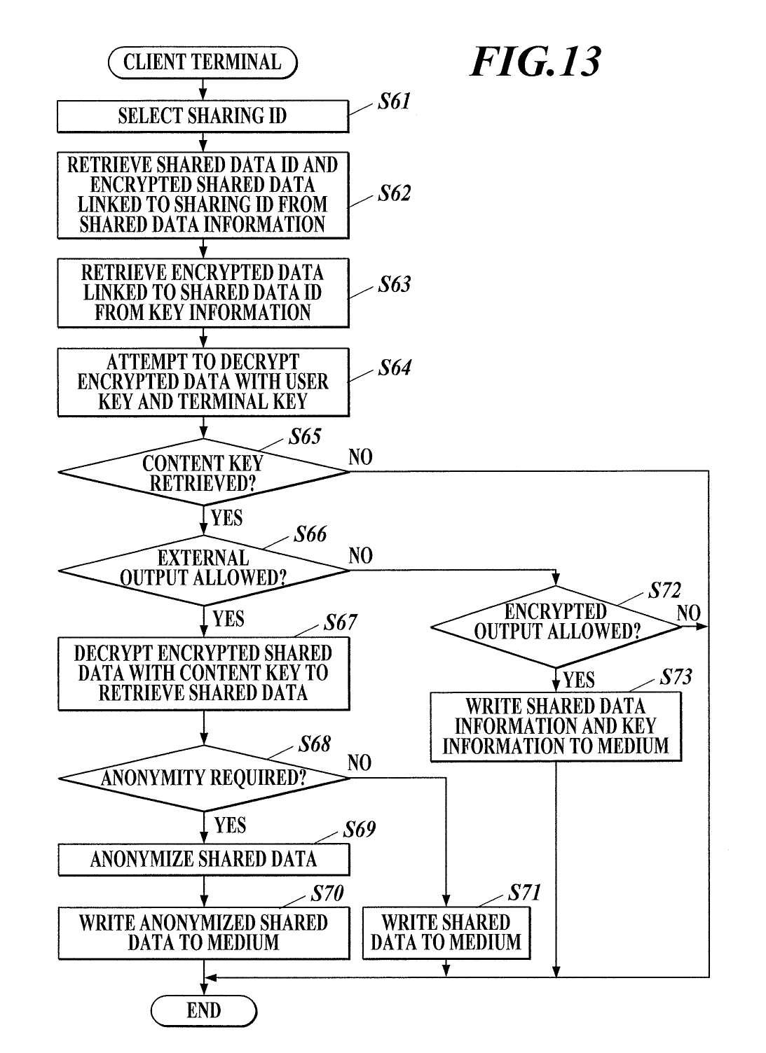

FIG. 13 is a flowchart illustrating an output sequence executed by the client terminal 20. The output sequence illustrates the process of outputting medical information to the medium M1.

The processing in Step S61 to Step S64 is identical to the processing in Step S51 to S54 in FIG. 12, and the description thereof is omitted.

Then, if the attempt to decrypt the encrypted data with the user key and the terminal key succeeds so that the content key is retrieved (Step S65, Yes), the processor 21 makes a determination as to whether external output of the shared data is allowed based on the permission information that has been retrieved by decrypting the encrypted data (Step S66). Specifically, if the permission type “external output” is in the validity period and is also linked to the user ID of the current user of the client terminal 20 and the terminal ID of the client terminal 20 in the permission information, the processor 21 determines that external output of the shared data is allowed.

If external output of the shared data is allowed (Step S66, Yes), the processor 21 decrypts the encrypted shared data by using the content key that has been retrieved by decrypting the encrypted data, so as to retrieve the shared data (Step S67).

Then, the processor 21 makes a determination as to whether external output requires anonymity based on the permission information (Step S68). Specifically, if the anonymity requirement of the permission type “external output” is “Yes” in the permission information, the processor 21 determines that external output requires anonymity.

If external output requires anonymity (Step S68, Yes), the processor 21 anonymizes the shared data (Step S69) and controls the data writer 27 to write the anonymized shared data to the medium M1 (Step S70).

In Step S68, if external output does not require anonymity (Step S68, No), the processor 21 controls the data writer 27 to write the shared data to the medium M1 (Step S71).

In Step S66, if external output of the shared data is not allowed (Step S66, No), the processor 21 makes a determination as to whether encrypted output of the shared data is allowed based on the permission information (Step S72). Specifically, if the permission type “encrypted output” is in the validity period and is also linked to the user ID of the current user of the client terminal 20 and the terminal ID of the client terminal 20 in the permission information, the processor 21 determines that encrypted output of the shared data is allowed.

If encrypted output of the shared data is allowed (Step S72, Yes), the processor 21 controls the data writer 27 to write the shared data information V3 and the key information V4 of the shared data of the output object to the medium M1 (Step S73).

After Step S70, Step S71 or Step S73 is performed, or if the content key cannot be retrieved in Step S65 (Step S65, No), or if encrypted output of the shared data is not allowed in Step S72 (Step S72, No), the output sequence ends.

As described above, in the medical information management system 100 of the first embodiment, a content key is generated, the shared data is encrypted by using the content key so that an encrypted shared data is generated, the content key and permission information of the shared data are encrypted by using partner keys (terminal key, user key) of the disclosee (terminal ID, user ID) specified in the permission information so that an encrypted data is generated every time shared data is downloaded, and the encrypted shared data and the encrypted data are provided to a client terminal 20 that made a download request. Therefore, it is possible to prevent leakage of the shared data and to restrict reference and/or output of the shared data.

In the client terminal 20, shared data and a content key are saved in an encrypted state even after the shared data is downloaded from the management server 10. Therefore, it is possible to improve the security level by allowing the decryption only when an authorized user uses an authorized client terminal 20. For example, when the content key is encrypted by using a user key, it is impossible to retrieve the shared data without an IC card C1 in which the user key is saved.

Further, a user and a client terminal 20 with suitable authority can decrypt an encrypted data even off line by using a user key and a terminal key that the client terminal 20 can retrieve, so as to retrieve a content key.

When external output is not allowed but encrypted output is allowed in a certain client terminal 20, it is possible to directly output such encrypted data (shared data information V3 and key information V4). By retrieving the shared data information V3 and the key information V4 from the medium M1, another client terminal 20 can decrypt the shared data with an available user key and an available terminal key to retrieve the content key even offline when a user of the client terminal 20 and the client terminal itself 20 are allowed to reference and/or output the shared data.

Further, since a validity period is set for permission information, it is possible to restrict disclosure of a downloaded shared data in terms of time.

### Second Embodiment

Next, a second embodiment of the present invention will be described.

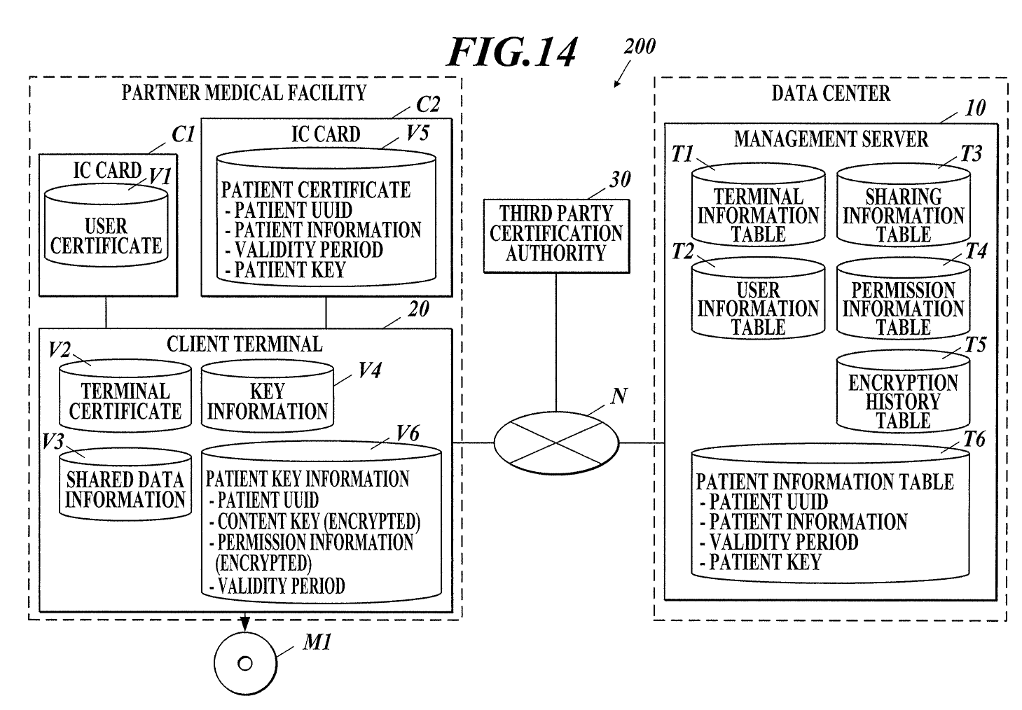

FIG. 14 illustrates the system configuration of a medical information management system 200 according to a second embodiment. The medical information management system 200 further controls reference and/or output of medical information by using a patient key in addition to the processing performed by the medical information management system 100 according to the first embodiment.

The functional configuration of a management server 10 and the functional configuration of the client terminal 20 are the same as those illustrated in FIG. 2 and FIG. 5. Accordingly, the same reference signs are denoted to the same components, and the graphic illustration and description thereof are omitted.

Hereinafter, configurations and processing that are characteristic to the second embodiment will be described.

The management server 10 includes a patient information table T6 in addition to a terminal information table T1, a user information table T2, a sharing information table T3, a permission information table T4 and an encryption history table T5. The patient information table T6 is stored in a storage 14.

In the patient information table T6, information on each patient is stored with regard to medical information that is shared among partner medical facilities by means of the medical information management system 200. In the patient information table T6, “patient information”, a “validity period” and a “patient key” are linked to a “patient UUID” (second storage). Each patient can be set as a partner to share medical information and is therefore a potential disclosee of the medical information.

The “patient UUID” is identification information for identifying a patient.

The “patient information” is information on a patient and includes the name, birth date, sex and the like of the patient.

The “validity period” is a period in which the “patient key” linked to the “patient UUID” is available.

The “patient key” is a key provided to a patient identified by the “patient UUID” and is unique to each patient.

In the second embodiment, patient key usage allowance is further linked to each of the permission types (image reference, patient reference, external output, encrypted output) of each shared data ID in the permission information of FIG. 3 in addition to a validity period, a user ID, a terminal ID and an anonymity requirement (first storage).

The patient key usage allowance is information on whether the patient key is available to the linked shared data. When the patient key usage allowance is “Yes”, it is possible to retrieve a content key by using the patient key when shared data is downloaded. That is, when the patient key usage allowance is “Yes”, “the patient of the medical information (shared data)” is included as a disclosee in the permission information. In the second embodiment, a case in which the patient key usage allowance in the permission information is “Yes” is described.

In response to a download request of medical information (shared data) from one of client terminals 20, the processor 11 generates a content key and encrypts the medical information by using the generated content key so as to generate an encrypted shared data every time the medical information is downloaded. That is, the processor 11 functions as the first generator.

The processor 11 retrieves permission information of the medical information (shared data) encrypted with the content key from the permission information table T4 stored in the storage 14.

The processor 11 retrieves a partner key (patient key) of the disclosee (patient of the medical information) included in the retrieved permission information, i.e. a patient key of the patient of the medical information encrypted with the content key, from the patient information table T6 stored in the storage 14.

The processor 11 encrypts the content key and the permission information of the medical information (shared data) encrypted with the content key by using the patient key so as to generate a patient key-encrypted data, which corresponds to the second information. That is, the processor 11 functions as the second generator.

The processor 11 provides the encrypted shared data and the patient key-encrypted data to the client terminal 20 that made the download request via the communicating section 13. That is, the processor 11 functions as the provider.

The client terminal 20 retrieves information from an IC card C2. The IC card C2 is a card owned by each patient, in which a patient certificate V5 of the patient is stored. The patient certificate V5 includes the “patient UUID”, the “patient information” and a “validity period” and the “patient key”.

The client terminal 20 stores patient key information V6 and the like in addition to the terminal certificate V2, the shared data information V3 and the key information V4. The patient key information V6 is stored in a storage 28.

The patient key information V6 is information on the patient key required for decrypting the encrypted shared data, which includes the “patient UUID”, the “patient key-encrypted data (the content key and permission information encrypted with the patient key) and a “validity period”.

An IC card reader/writer 26 reads a variety of information from the IC card C2 and outputs the read data to a processor 21. Further, the IC card reader/writer 26 writes a variety of data to the IC card C2.

When uploading medical information, the processor 21 sends medical information (shared data) that is selected on an operation section 24 to the management server 10 via the communicating section 23. The processing in this process is similar to the upload sequence as illustrated in FIG. 9 except that the patient key usage allowance is further set in Step S22 of setting the permission information.

When downloading medical information, the processor 21 retrieves a shared data ID, and an encrypted shared data and all of encrypted data (the content key and permission information encrypted with the terminal key and the user key) and a patient key-encrypted data (content key and permission information encrypted with the patient key) that are linked to the shared data ID from the management server 10 via the communicating section 23.

The processor 21 controls the IC card reader/writer 26 to retrieve a patient key (partner key) stored in the IC card C2. That is, the processor 21 functions as the first retrieving section.

The processor 21 checks whether it is possible to decrypt the patient key-encrypted data retrieved from the management server 10 by using the patient key that the client terminal 20 has.

The processor 21 decrypts the patient key-encrypted data retrieved from the management server 10 by using the patient key retrieved from the IC card C2, so as to retrieve the content key and the permission information. That is, the processor 21 functions as the second retrieving section.

The processor 21 decrypts the encrypted shared data retrieved from the management server 10 within the scope of authority according to the retrieved permission information by using the retrieved content key, so as to retrieve the medical information (shared data). That is, the processor 21 functions as the third retrieving section.

Next, the operation of the medical information management system 200 will be described. In the following processing, the processing in the management server 10 is achieved by software processing of the processor 11 in cooperation with a server program P1 stored in a storage 14, and the processing in the client terminal 20 is achieved by software processing of the processor 21 in cooperation with an application program P2 stored in the storage 28.

### Patient Registration Sequence

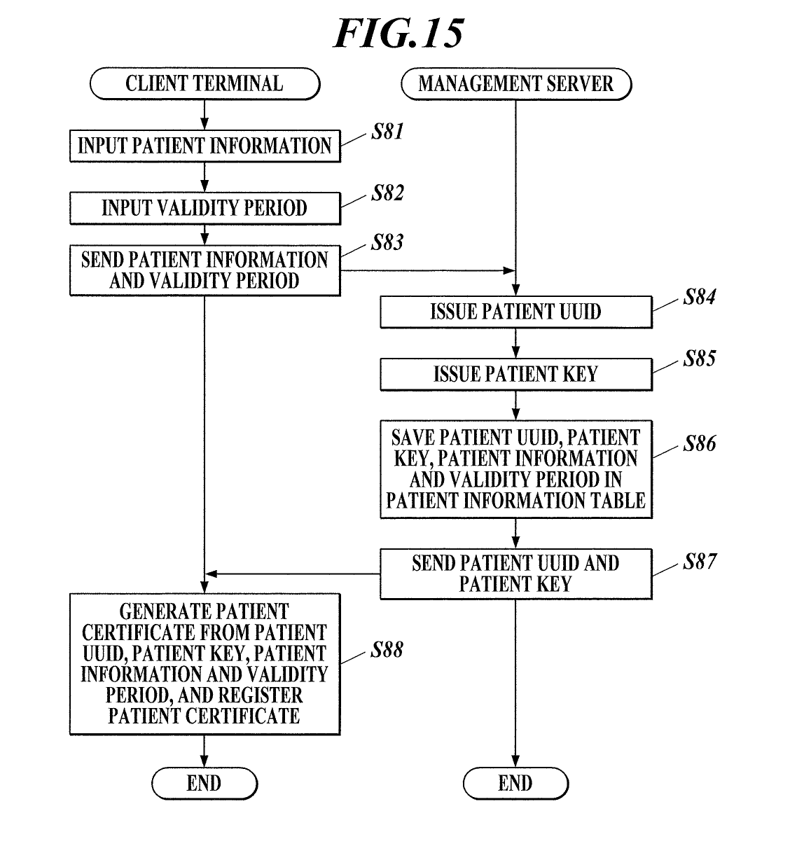

FIG. 15 is a ladder chart illustrating a patient registration sequence. The patient registration sequence illustrates the process of registering a patient as an authorized patient in the medical information management system 200.

First, in the client terminal 20, the user inputs patient information and a validity period on an operation section 24, and the processor 21 retrieves the input information (Step S81, Step S82).

Then, the processor 21 sends the patient information and the validity period to the management server 10 via a communicating section 23 (Step S83) and requests registration of the patient.

When the management server 10 receives the patient information and the validity period from the client terminal 20 through the communicating section 13, the processor 11 issues a patient UUID to a patient to be registered, which does not overlap with patient UUIDs of the other patients (Step S84).

Then, the processor 11 issues a patient key to the patient to be registered (Step S85).

Then, the processor 11 links the patient UUID issued in Step S84, the patient key issued in Step S85 and the patient information and the validity period received from the client terminal 20 to each other and saves them in the patient information table T6 (Step S86).

Then, the processor 11 sends the patient UUID and the patient key to the client terminal 20 via the communicating section 13 (Step S87).

In the client terminal 20, the processor 21 generates a patient certificate V5 from the patient UUID and the patient key sent from the management server 10, the patient information input in Step S81 and the validity period input in Step S82. The processor 21 controls the IC card reader/writer 26 to write the patient certificate V5 to the IC card C2 so as to register the patient certificate V5 (Step S88).

Then, the patient registration sequence ends.

When uploading medical information (shared data), the shared data is linked to the patient UUID of the patient of the shared data, and they are stored in the storage 14 of the management server 10.

### Download Sequence Involving Usage of Patient Key

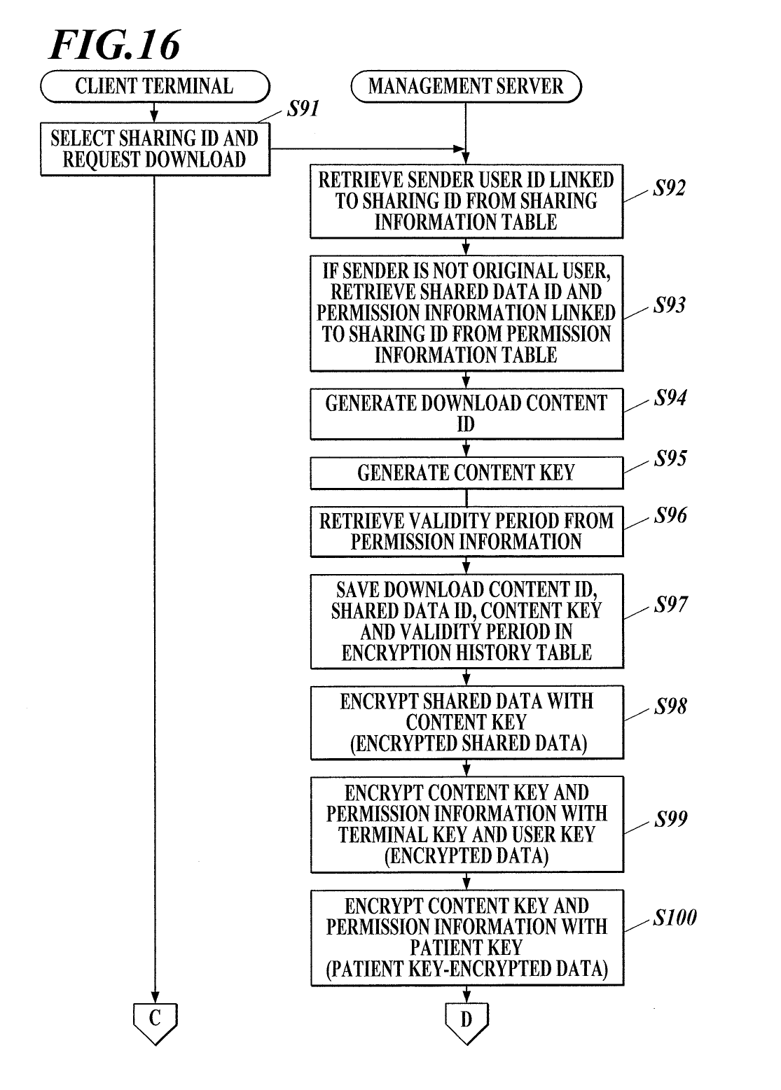

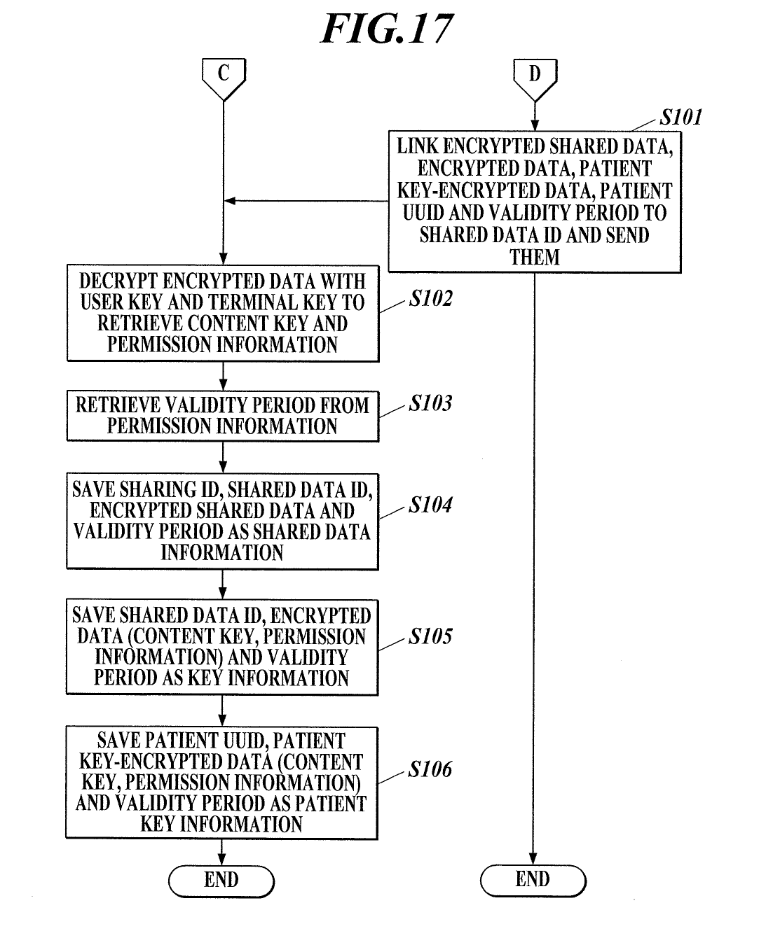

FIG. 16 and FIG. 17 are a ladder chart illustrating a download sequence that involves usage of a patient key. The download sequence that involves usage of a patient key is executed when the patient key usage allowance is “Yes” in the permission information of medical information (shared data) of a download object. For example, a situation where a patient key is used is such that a patient visits a medical facility with an IC card C2 and shows the IC card C2 to a doctor of the facility, and the doctor sets the IC card C2 to an IC card reader/writer 26 of a client terminal 20. In the following description, the part of processing that is different from the processing of the first embodiment will be mainly described.

The processing in Step S91 to Step S99 are the same as the processing in Step S31 to Step S39 in FIG. 10, and the description thereof is omitted.

Then, in the management server 10, the processor 11 encrypts the content key generated in Step S95 and the permission information retrieved in Step S93 by using the patient key, so as to generate a patient key-encrypted data (Step S100). Specifically, the processor 11 retrieves the patient UUID of the shared data, retrieves the patient key linked to the patient UUID from the patient information table T6 and encrypts the content key and the permission information by using the patient key.

When the validity period of the patient UUID has already ended in the patient information table T6, it is determined that the patient key linked to the patient UUID is not available.

Then, continued to FIG. 17, the processor 11 links the encrypted shared data generated in Step S98, the encrypted data generated in Step S99, the patient key-encrypted data generated in Step S100, the patient UUID of the shared data and the validity period retrieved in Step S96 to the shared data ID and send them to the client terminal 20 via the communicating section 13 (Step S101). In Step S101, the patient key-encrypted data, the patient UUID and the validity periods are further sent from the management server 10 to the client terminal 20 in addition to the processing of Step S40 in FIG. 11.

The processing in Step S102 to Step S105 are the same as the processing in Step S41 to Step S44 in FIG. 11, and the description thereof is omitted.

Then, in the client terminal 20, the processor 21 saves the patient UUID received from the management server 10, the patient key-encrypted data (content key and the permission information encrypted by the patient key) and the validity period to the storage 28 as the patient key information V6 (Step S106).

Then, the download sequence involving usage of the patient key ends.

When the downloaded encrypted shared data is referenced and/or output in the client terminal 20, the processor 21 specifies an object shared data (shared data ID), retrieves the patient UUID of the shared data from the management server 10 and retrieves the patient key-encrypted data linked to the patient UUID from the patient key information V6.

Then, the processor 21 controls the IC card reader/writer 26 to retrieve the patient key from the patient certificate V5 stored in the IC card C2. The processor 21 attempts to decrypt the patient key-encrypted data by using the patient key. When the attempt to decrypt the patient key-encrypted data succeeds so that the content key and the permission information are retrieved, it is no longer required to decrypt the encrypted data by using the user key and the terminal key. That is, when the patient key is available, it is possible to retrieve the content key even without the user key and the terminal key. When the attempt to decrypt the patient key-encrypted data with the patient key fails, the encrypted data may be decrypted by using the user key and the terminal key as with the first embodiment.

As described above, in the medical information management system 200 of the second embodiment, a content key is generated, the shared data is encrypted with the content key so that an encrypted shared data is generated, the content key and the permission information of the shared data are encrypted with a patient key so that a patient key-encrypted data is generated every time shared data is downloaded, and the encrypted shared data and the patient key-encrypted data are provided to a client terminal 20 that made a download request. Therefore, it is possible to prevent leakage of the shared data and to restrict reference and/or output of the shared data.

For example, by reading an IC card C2 in which a patient certificate V5 is registered, the patient key of a certain patient becomes available to a doctor (user) who becomes in charge of the patient.

The above description of the embodiments is merely examples of the medical information management system of the present invention, and the present invention is not limited thereto. Further, suitable changes can be made in the detailed configuration and the detailed operation of each device of the systems without departing from the feature of the present invention.

For example, the above-described embodiments illustrate examples in which shared data corresponds to a unit of medical information. However, the unit of encrypting the medical information is not particularly limited.

The first embodiment illustrates an example in which a content key and permission information are encrypted by using a user key and a terminal key, and the second embodiment illustrates an example in which a content key and permission information are encrypted by using a user key and a terminal key while the content key and the permission information are also encrypted by using a patient key. However, the combination of the keys (user key, terminal key, patient key) may be suitably selected.

This U.S. patent application claims priority to Japanese patent application No. 2015-206842 filed on Oct. 21, 2015, the entire contents of which are incorporated by reference herein for correction of incorrect translation.

What is claimed is:

1. A medical information management system comprising:
a management server which manages medical information generated in medical facilities; and
client terminals which are installed in the medical facilities and which are connected to the management server so that data communication is possible,
wherein the management server comprises:
a first storage which stores permission information including a disclosee with respect to each of the medical information;
a second storage which stores a partner key with respect to each partner to share the medical information, the partner being a candidate of the disclosee;
a first generator which, in response to a download request of the medical information from one of the client terminals, generates a content key and encrypts the medical information by using the generated content key, so as to generate first information every time the medical information is downloaded;
a second generator which encrypts the content key and the permission information of the medical information encrypted with the content key by using the partner key of the disclosee included in the permission information, so as to generate second information; and
a provider which provides the first information and the second information to the client terminal which makes the download request, and
wherein each of the client terminals comprises:
a first retrieving section which retrieves the partner key;
a second retrieving section which decrypts the second information retrieved from the management server by using the partner key retrieved by the first retrieving section, so as to retrieve the content key and the permission information; and
a third retrieving section which decrypts the first information retrieved from the management server by using the content key retrieved by the second retrieving section within a scope of authority according to the permission information retrieved by the second retrieving section, so as to retrieve the medical information.

2. The medical information management system according to claim 1, wherein the partner key is a user key provided to each user, a terminal key provided to each of the client terminals or a patient key provided to each patient of the medical information.

3. The medical information management system according to claim 1, wherein the permission information further includes a validity period or a permission type of the medical information.

4. The medical information management system according to claim 1, wherein each of the client terminals further comprises:
a writer which writes the first information and the second information retrieved from the management server to a recording medium when encrypted output is allowed in the permission information retrieved by the second retrieving section.

5. A management server which is connected to client terminals installed in medical facilities so that data communication is possible and which manages medical information generated in the medical facilities, comprising:
a first storage which stores permission information including a disclosee with respect to each of the medical information;
a second storage which stores a partner key with respect to each partner to share the medical information, the partner being a candidate of the disclosee;
a first generator which, in response to a download request of the medical information from one of the client terminals, generates a content key and encrypts the medical information by using the generated content key, so as to generate first information every time the medical information is downloaded;
a second generator which encrypts the content key and the permission information of the medical information encrypted with the content key by using the partner key of the disclosee included in the permission information, so as to generate second information; and
a provider which provides the first information and the second information to the client terminal which makes the download request.
